(19) United States
(12) Patent Application Publication
(10) Pub. No.: US 2008/0268780 A1
(43) Pub. Date: Oct. 30, 2008

(54) WIRELESS NOTIFICATION APPARATUS AND METHOD

(76) Inventors: Jeffry W. Werner, Cambridge (CA); Eric Grant-O'Grady, Kitchener (CA); Terrance M. Sharp, Milton (CA)

Correspondence Address: BERESKIN AND PARR, 40 KING STREET WEST, BOX 401, TORONTO, ON, M5H 3Y2, CA

(21) Appl. No.: 12/109,407

(22) Filed: Apr. 25, 2008

Related U.S. Application Data
(60) Provisional application No. 60/924,028, filed on Apr. 27, 2007.

(51) Int. Cl. H04B 7/00; H04B 1/38; H04M 1/00

(52) U.S. Cl. 455/41.2; 455/567; 455/569.1; 455/90.3

(57) ABSTRACT

A notification apparatus for alerting the user of a wireless device to an event, such as an incoming communication or calendar reminder. When the event occurs, the wireless device may send out a notification signal using a wireless protocol. The notification apparatus detects the notification signal using a wireless transceiver and activates a signaling device which alerts the user to the event.

### CROSS-REFERENCE TO RELATED APPLICATIONS

This application claims priority to U.S. Prov. App. No. 60/924,028 filed Apr. 27, 2007, entitled “WIRELESS NOTIFICATION APPARATUS,” which is incorporated by reference herein in its entirety.

### FIELD OF THE INVENTION

This invention relates to notification devices and methods, and in particular a wireless communication-enabled notification apparatus for a wireless device as well as methods for alerting a user of a wireless device.

### BACKGROUND OF THE INVENTION

The use of wireless devices, such as cellular phones, wireless email devices, and personal digital assistants (PDAS) is widespread throughout the world. These wireless devices are small, portable and allow the user to be contacted at virtually any time and at virtually any location.

Wireless devices alert their user that they are being contacted, for example when a phone call or an email is received. In addition, these devices may alert the user of an upcoming meeting, or a task due date. The wireless device may alert the user via sound, vibration, or visible light (such as an LED light). However, in order for a user to be alerted, the user must be able to hear, see or feel the notification from the wireless device. This may at times cause problems for the user. For example, if the wireless device is in the user's pocket, bag, or purse, the user may not notice the alert. If a user is not aware of the alert, important events, communication, or information may be missed.

### SUMMARY OF THE INVENTION

The invention provides in one aspect, a wireless communication-enabled notification apparatus for a wireless device, the notification apparatus comprising:

a) a housing including a base plate;

b) an anchoring device coupled to the base plate;

c) an integrated circuit located in the housing, wherein the integrated circuit comprises a wireless transceiver, wherein the wireless transceiver is adapted for wireless communication with the wireless device; and

d) a signaling device located in the housing, the signaling device adapted for activation by the integrated circuit, wherein the signaling device is adapted to alert the user of the wireless device to a notification signal sent by the wireless device in response to an event.

In another aspect, the present invention provides a method for alerting the user of a wireless device to an event using a wireless communication-enabled notification apparatus, the method comprising:

a) the notification apparatus receiving a notification signal from the wireless device; and

b) the notification apparatus alerting the user by emitting a signal; and

c) if an audio channel is directed to the notification apparatus by the wireless device with the notification signal, the notification apparatus redirecting the audio channel back to the wireless device.

### BRIEF DESCRIPTION OF THE DRAWINGS

For a better understanding of the present invention, and to show more clearly how it may be carried into effect, reference will now be made by way of example, to the accompanying drawings that show embodiments of the present invention.

FIG. 1 is a perspective view of a notification apparatus according to a first embodiment of the invention;

FIG. 2 is an exploded perspective view of the apparatus of FIG. 1;

FIG. 3 is a cross sectional view of the apparatus of FIG. 1;

FIG. 4 is a perspective view of a second embodiment of the notification apparatus;

FIG. 5 is an exploded perspective view of the apparatus of FIG. 4; and

FIG. 6 is a cross sectional view of the apparatus of FIG. 4.

FIG. 7 is a perspective view of the third embodiment of the notification apparatus;

FIG. 8 is a is an exploded perspective view of the apparatus of FIG. 7;

FIG. 9 is a cross sectional view of the apparatus of FIG. 7;

FIG. 10 is a flowchart illustrating a notification method according to an embodiment of the present invention; and

FIG. 11 is a flowchart illustrating an embodiment of a notification method where an audio communication is received by the wireless device.

For simplicity and clarity of illustration, elements shown in the figures have not necessarily been drawn to scale. Further, where considered appropriate, reference numerals may be repeated among the figures to indicate corresponding or analogous elements.

### DETAILED DESCRIPTION OF THE INVENTION

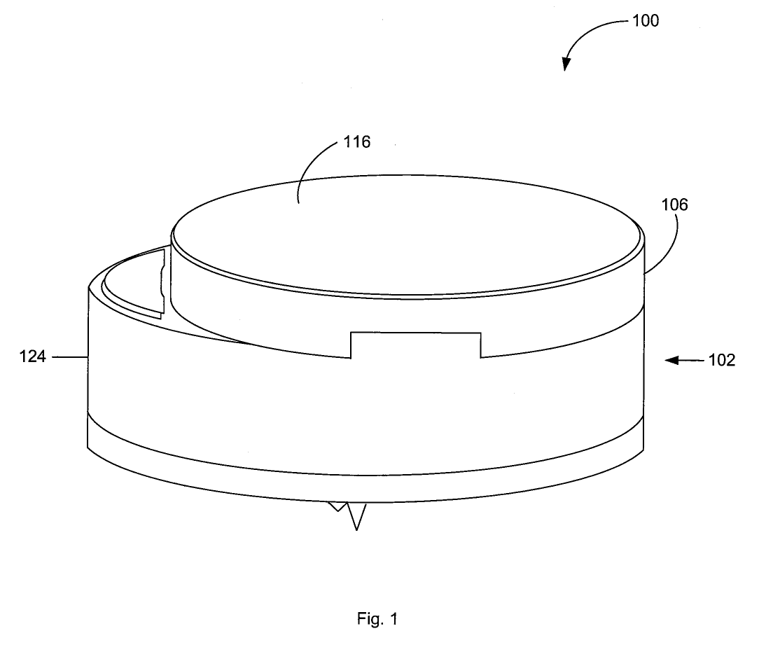

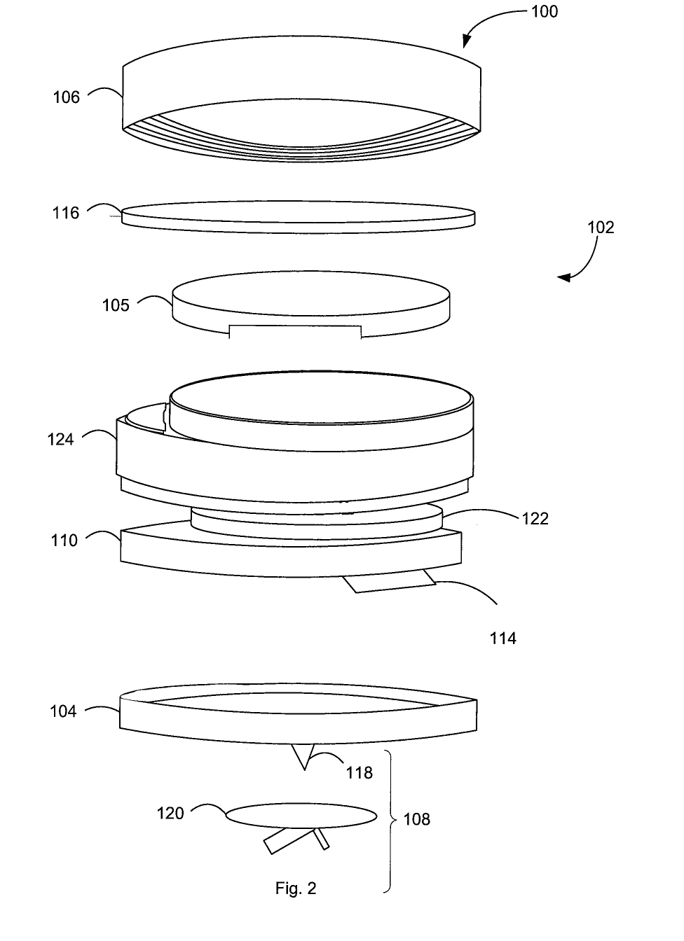

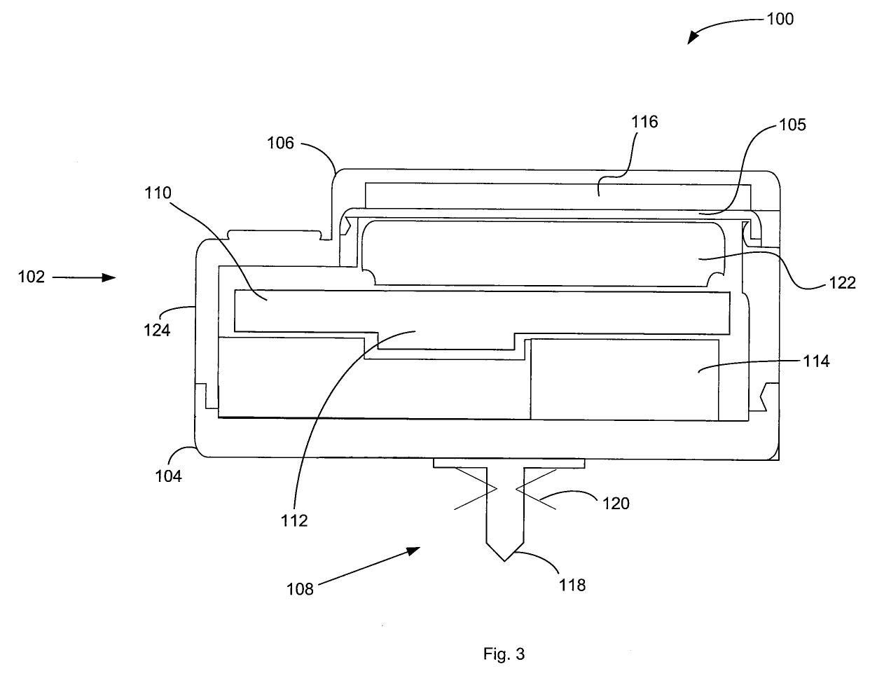

Reference is first made to FIGS. 1, 2 and 3, which illustrate a first embodiment of a notification apparatus 100. The notification apparatus 100 is enabled for wireless communication using, for example, Bluetooth™ technology. The notification apparatus 100 comprises a housing 102 and an anchoring device 108 connected to the housing. An integrated circuit 110 which includes a wireless transceiver 112, a signaling device 114, and a battery 122 are all located in the housing 102.

The notification apparatus 100 may be of any shape or configuration. In one embodiment, the notification apparatus 100 is an oblong hollow garment pin. In this embodiment, the notification apparatus 100 may be worn as a garment pin on a lapel or other clothing. In other embodiments (not shown), the notification apparatus 100 may be a tie clip, a broach, a pen, a hair restraint device, a necklace, a ring, an earring etc. Preferably, the notification apparatus 100 is small, portable and simple for a user to attach in a location where the notification apparatus 100 can be easily noticed or heard. For example, the notification apparatus 100 may be pinned to the user's clothing or bag strap, etc. The notification apparatus 100 may also be adapted to coordinate with the clothing of the user, as described in more detail below.

In some embodiments, the housing 102 is made up of a base plate 104, a cover 124, and a battery cover 105. Preferably, the base plate 104, the cover 124, and the battery cover 105 are connected to each other by snapping together the base plate 104, the cover 124, and the battery cover 105. The housing 102 provides an outer shell in which the other components, such as the integrated circuit 110, signaling device 114, and battery 122 are located. In other embodiments, the base plate 104 and the cover 124 may be permanently secured. The housing 102 may, for example, help prevent damage to components of the notification apparatus 100 if the notification apparatus 100 is dropped or impacted.

The notification apparatus 100 may alternatively use a rechargeable battery 122 in which case, the battery cover 105 would become part of the housing 102 and a battery port may be included through which the rechargeable battery may be charged.

Continuing to refer to FIGS. 1-3, a face plate 106 may be removably secured to the cover 124 of the housing 102 in any suitable fashion, such as magnets or by a friction fit. The face plate 106 may display a logo, a charitable organization symbol, a sports team logo, a religious symbol, an advertisement, or any other type of visual image. In one embodiment, the logo may be displayed on a removable plate 116 magnetically coupled to the face plate 106 to permit a user to quickly change the logo. The face plate 106 and removable plate 116 preferably permit the user to quickly and easily change the appearance of the housing 102 to fit individual tastes.

Preferably, the anchor device 108 is coupled to the base plate 104 of the housing 102. The anchor device 108 permits the user to securely attach the device 100 to clothing, bag straps, or the like. In one embodiment, the anchor device 108 may be a pin 118 connected to the base plate, and a backing 120 which is removably securable to the pin 118.

To secure the anchor device 108 to clothing, the pin 118 is pierced through the clothing, following which the backing 120 is secured to the distal end of the pin 118.

The integrated circuit 110 may be any type of microchip adapted for use with a wireless protocol such as, for example, the Bluetooth™ wireless protocol.

Bluetooth™ is a low-cost, low-power, and widely used wireless communication protocol, which has been built in many types of wireless devices. The wireless link created by Bluetooth™ enabled devices typically operates to transmit a voice and/or data signal within a localized range. The range of Bluetooth™ enabled devices can vary depending on factors such as power and interference from surroundings. Typically, the Bluetooth™ enabled devices operate in the unlicensed ISM band at 2.4 GHz. The Bluetooth™ protocol is widely used, and allows easy interoperability between various Bluetooth™ enabled wireless devices.

However, while the embodiments described herein will generally described in relation to Bluetooth™ protocols, it is to be understood that any type of wireless protocol or short range connection may be used. For example, the notification apparatus 100 may use any type of WPAN (wireless personal area network) or NFC (near field communication) technology to communicate with the wireless device.

Continuing to refer to FIGS. 1-3, the integrated circuit 110 comprises a wireless transceiver 112. In one embodiment, the integrated circuit 110 is built into the wireless transceiver 112. The wireless transceiver 112 is wirelessly linked to a wireless device (not shown), such as a cellular phone, PDA, or smartphone. For example, the wireless transceiver 112 is capable or sending a signal to the wireless device and receiving a signal from the wireless device (not shown).

In one embodiment, where Bluetooth™ technology is used, any Bluetooth™ enabled wireless device will be capable of being paired to the notification apparatus 100, or a plurality of notification apparatuses 100. Pairing a wireless device to a notification apparatus 100 permits the wireless device to selectively communicate with the notification apparatus 100 via the Bluetooth™ communication protocol. Typically, once a wireless device is paired to a notification apparatus 100, the wireless device can transmit signals to the wireless transceiver 112 of the notification apparatus 100. For example, in the case of a cell phone wireless device, the cell phone may transmit a signal to the notification apparatus 100 that the cell phone is ringing.

One example method of pairing the notification apparatus 100 and the wireless device is to instruct the wireless device to search for other Bluetooth™ enabled devices within range of the wireless device's Bluetooth™ transceiver. Once the wireless device identifies the notification apparatus 100, a four-digit confirmation code may be entered into the wireless device, where the confirmation code completes the pairing between the notification apparatus 100 and the wireless device.

The integrated circuit 110 may store a series of commands or instructions to enable the functionality described above. For example, the instructions may be stored as firmware required for the operation of the notification apparatus 100. The integrated circuit 110 may be linked to, or may also comprise a memory, such as flash memory. The memory can store the commands, instructions or firmware. The instructions, firmware or series of commands stored, or linked to the integrated circuit may be default values, or they may be values input selectively, and alterable by the user. For example, the user may alter the commands, instructions or firmware to select the type of alert the signaling device 114 outputs. Some examples of alert types are sound, vibration or visible light. In other embodiments, if sound is selected, the user may be able to adjust the volume of the sound.

In some embodiments, the notification apparatus 100 may also comprise an activation button (not shown). The activation button may be connected to the integrated circuit 110, such that a user can selectively toggle between an on and off state by actuating the activation button. For example, if the user does not wish to be notified by the notification apparatus 100, the user can press the activation button to turn the notification apparatus 100 to an off state, whereby the notification apparatus 100 does not emit a signal when in the off state. Additionally, if the user wishes to allow the notification apparatus 100 to be able to emit a signal, he/she may press the activation button to turn the notification apparatus 100 to an on state.

Preferably, the signaling device 114 is electrically connected to the integrated circuit 110. The signaling device 114 selectively emits a signal when it receives an electronic communication from the integrated circuit 110.

The operation of the wireless notification apparatus according to a preferred embodiment of the present invention will now be described with reference to FIGS. 1-3. When a wireless device, such as a cell phone rings or produces any other type of alert, it may send a signal using preferably a built-in wireless transmitter. When the wireless transceiver 112 receives the wireless signal from the wireless device, the integrated circuit 110 processes the received wireless signal using the firmware. The integrated circuit 110 then outputs an electronic signal to the signaling device 114. When the signaling device 114 receives the electronic signal, it in turn emits a signal to alert the user even if the alert emanating from the wireless device is not noticed by the user.

In some embodiments, the signaling device 114 is an audio speaker adapted to selectively emit an audio signal or sound. For example a ring, ring-tone, or any audible signal or sound may be output by the signaling device. In other embodiments (not shown), the signaling device 114 may be a device that emits visible light, such as an LED. In other embodiments (not shown) the signaling device 114 may be a vibrating device. In yet another embodiment, the signaling device 114 may be a device that is capable of emitting a combination of sound, light, and/or vibration.

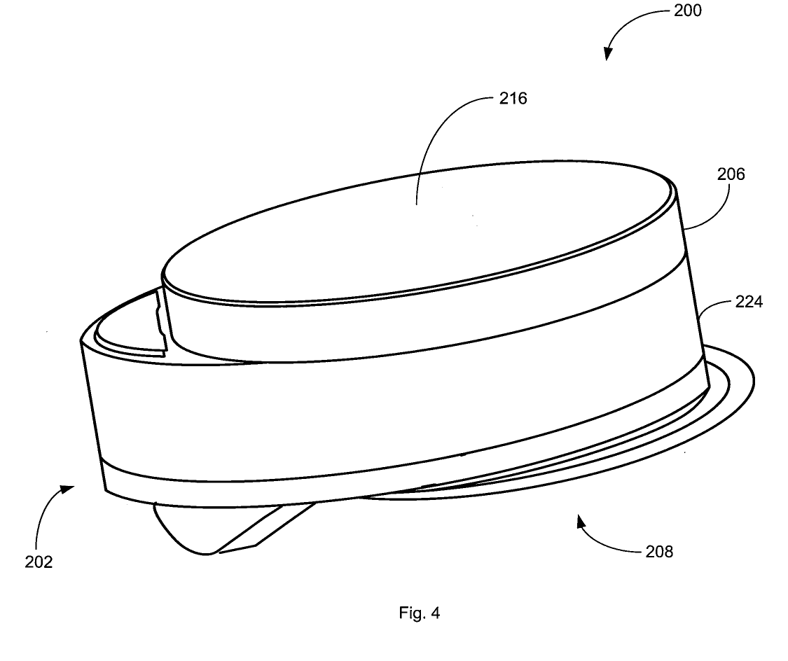

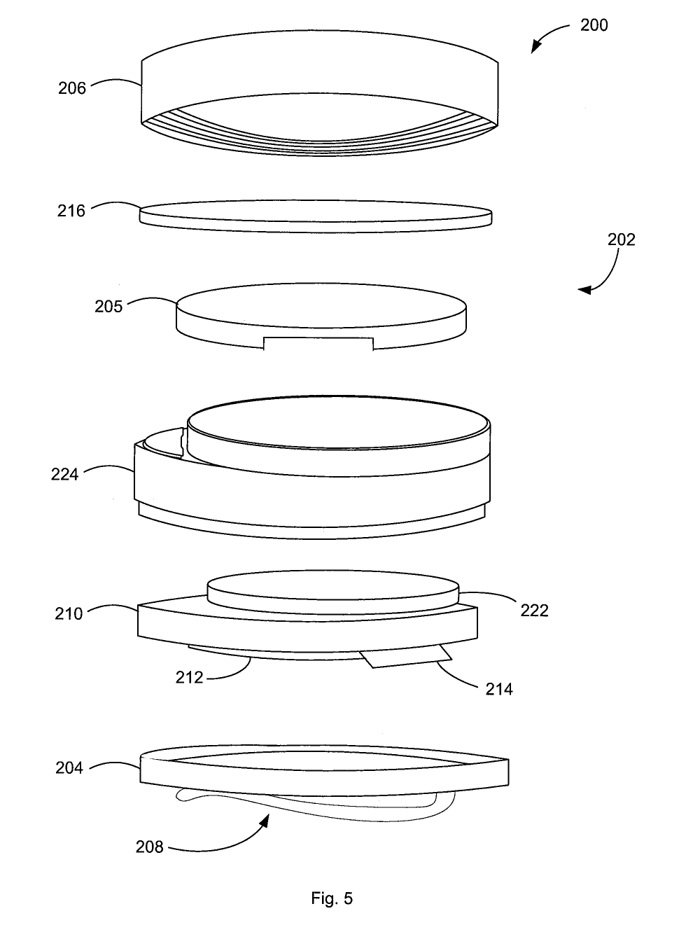

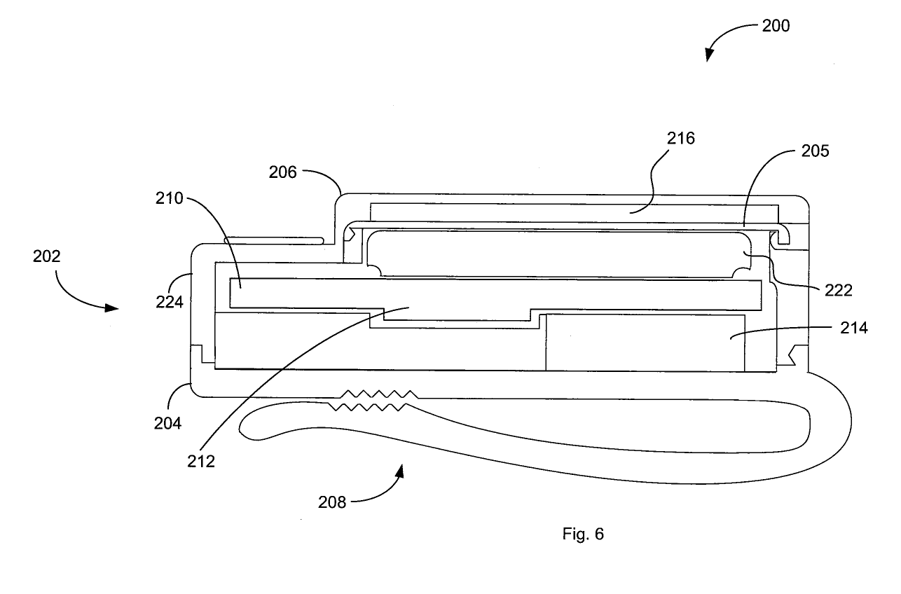

Reference is now made to FIGS. 4, 5 and 6, which show a notification apparatus 200, according to another embodiment of the present invention. Like parts are identified by like reference numbers and will not be further described. The notification apparatus 200 is substantially the same as the notification apparatus 100, except the anchoring device 208 is a clasp instead of a garment pin. In addition to being capable of being secured to clothing or the like, the clasp may allows the notification apparatus 200 to be secured to other objects, such as, for example a sun-visor in a car.

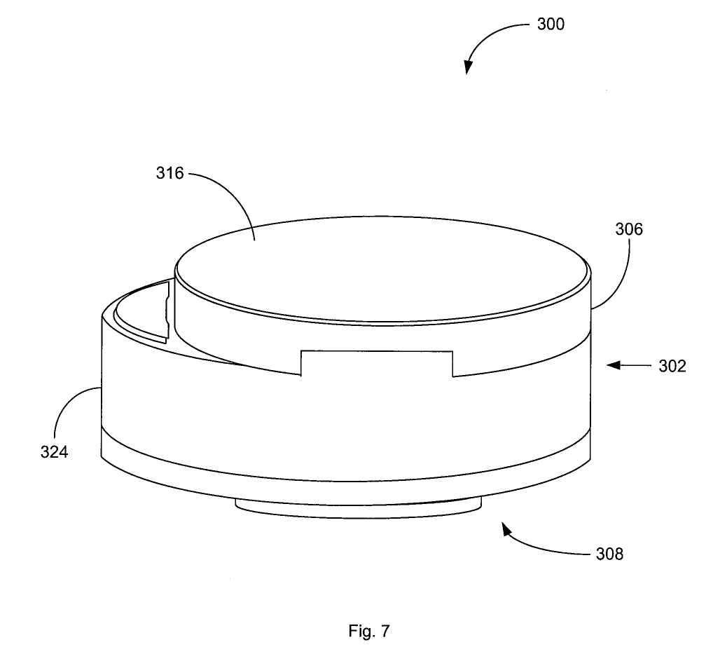

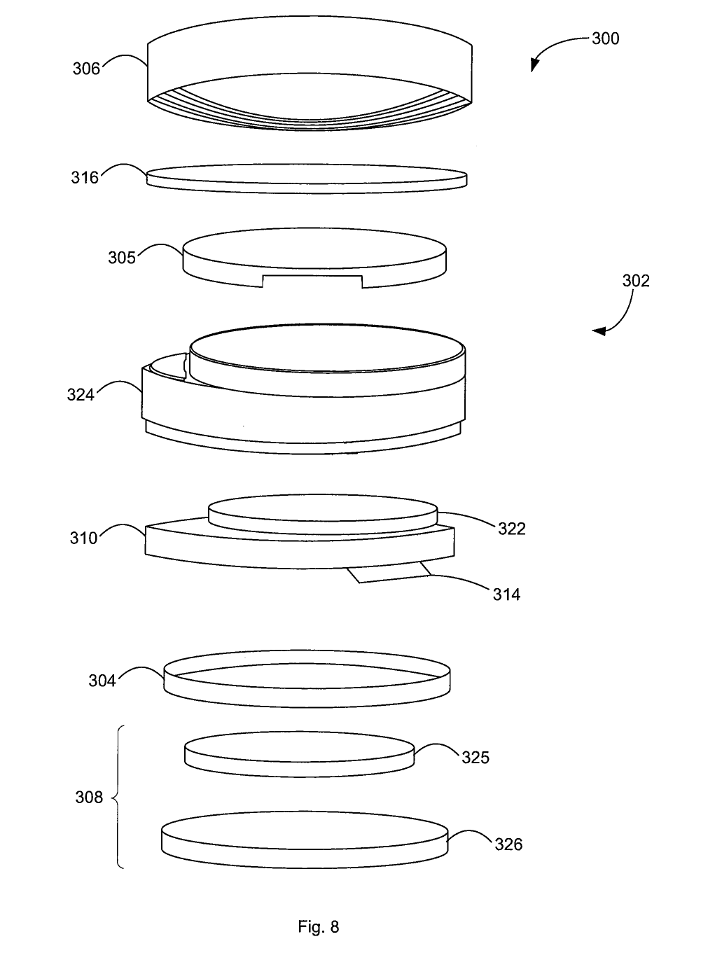

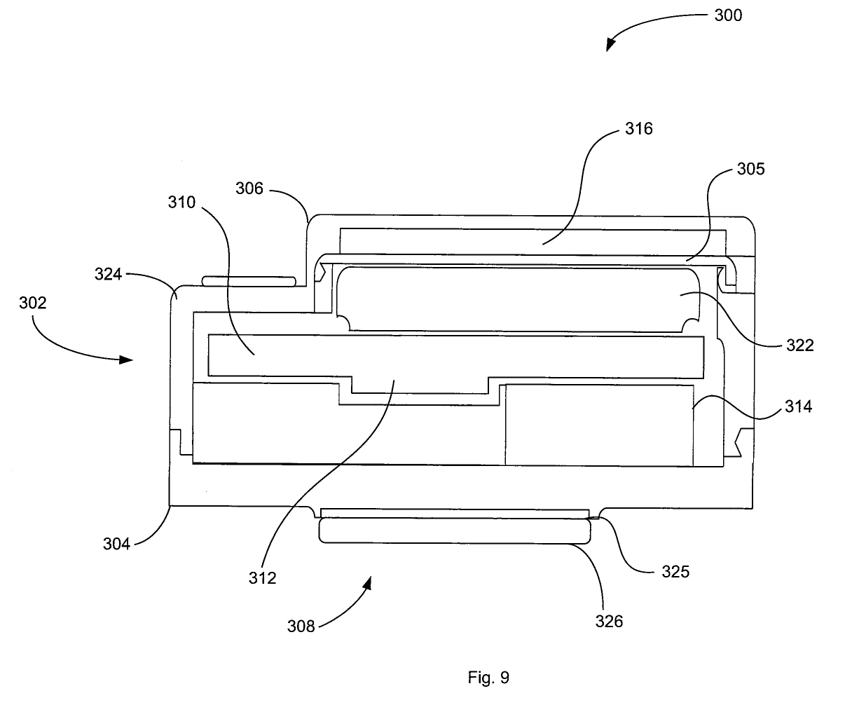

Reference is now made to FIGS. 7, 8 and 9, which show a notification apparatus 300, according to another embodiment of the present invention. Like parts are identified by like reference numbers and will not be further described. The notification apparatus 300 is substantially the same as the notification apparatuses 100 and 200, except the anchoring device 308 comprises a metal plate 325 and a magnet 326.

The magnet 326 may be removably attached to the metal plate 325, where the magnet 326 is coupled to the metal plate 325 by magnetic attraction.

To secure the anchor device 308 to clothing, bag straps or the like, the housing 302 is positioned against the outer surface of the article. The magnet 326 is then positioned on the inner surface of the article. The magnetic attraction between the magnet 326 and the metal plate 325 secure the notification apparatus 300 to the article.

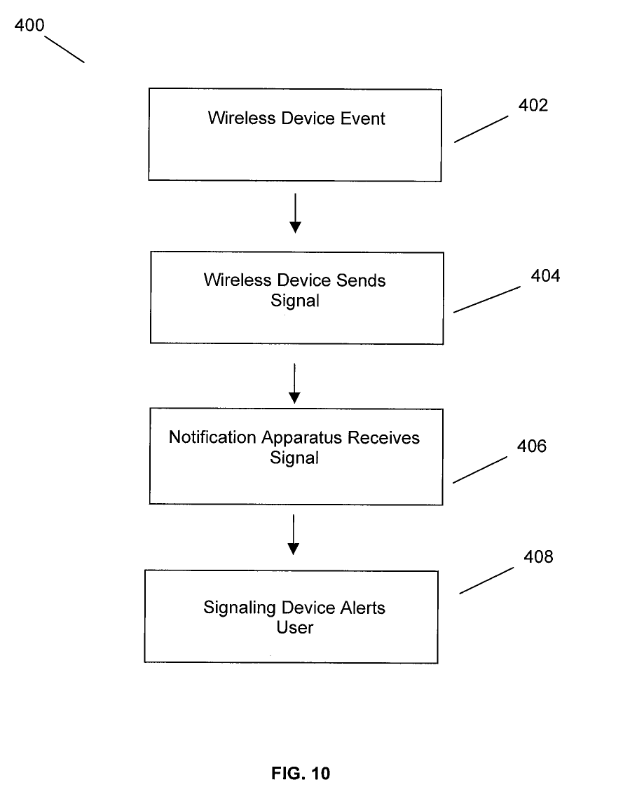

Referring now to FIG. 10, there is shown a flowchart illustrating the basic steps of a notification method 400 according to an embodiment of the present invention. The method 400 begins at step 402 where an event occurs in the wireless device to which the notification apparatus 100 is paired. This event may be the receipt a communication, such as an email, cellular telephone call or text message, or any other type of event, such as a calendar reminder or low-battery signal.

The method 400 then proceeds to step 404 where the wireless device transmits in any suitable fashion a notification signal with respect to the event. For example, the wireless device may transmit a notification that an incoming communication has been received. At step 406, preferably the wireless transceiver 112 of the notification apparatus 100 receives the notification signal from the wireless device. At step 408, the integrated circuit activates the signaling device 114 which alerts the user to the event. The type of alert given by the signaling device 114 may depend on the type of event. For example, the signaling device may provide a different signal for incoming telephone communications than it does for calendar reminders or incoming text messages.

If the event in the wireless device is not the receipt of an audio communication then the method 400 may terminate after the user has been alerted to the event. If the event in the wireless device is the receipt of an audio communication, however, then further steps may be required as described below.

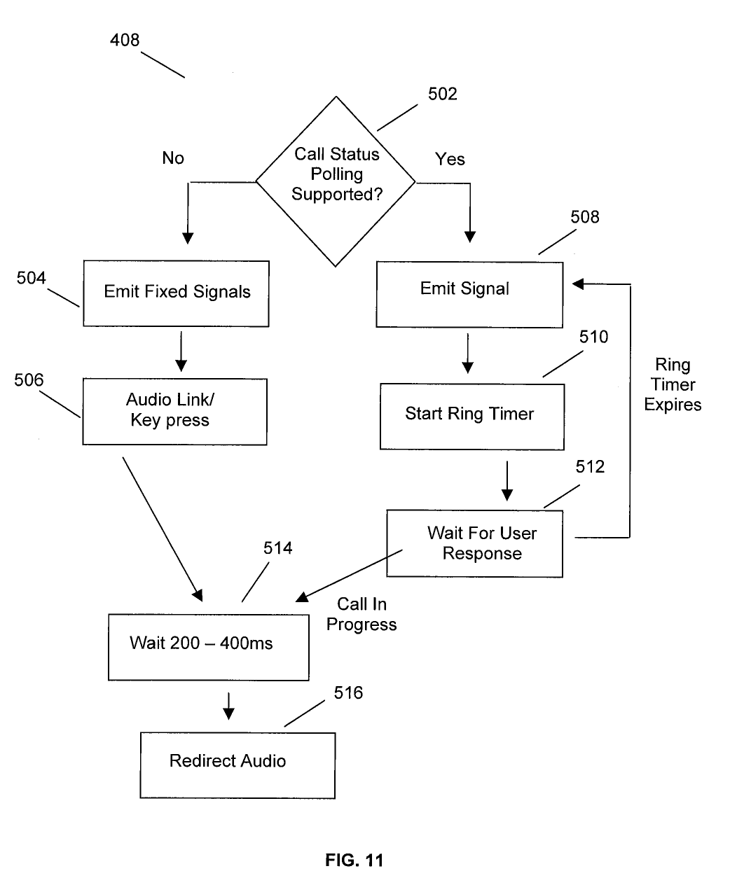

Referring now to FIG. 11, there is shown a flowchart illustrating the sub-steps of step 408 of method 400 where the event referred to with respect to FIG. 10 is an audio communication.

First, where the wireless device event is an incoming audio communication, the alert produced by the signaling deice 114 may depend on the type of wireless device to which the notification apparatus 100 is paired. For example, some wireless devices do not support a wireless protocol which would allow the notification apparatus 100 to poll the wireless device for a status report (referred to as call status polling) as to whether or not an incoming communication has been responded to by the user. This is the case where, for example, the wireless device supports only the basic Bluetooth™ Hands Free Protocol (HFP). The method used to alert the user to the incoming communication may depend on whether or not call status polling is supported. Thus, at step 502, the notification apparatus 100 determines whether or not call status polling is supported. If call status polling is not supported, the method proceeds to step 504 where the notification apparatus 100 alerts the user to an incoming communication by providing a set number of signals, for example a set number of beeps.

If, on the other hand, the wireless device does support a wireless protocol which allows call status polling, such as the full Bluetooth™ HFP, then the notification apparatus 100 may continue to emit signals until the incoming communication has been responded to by the user. In this case, the method proceeds to step 508 where the signaling device 114 produces an alert. The method then proceeds to step 510 where the notification apparatus 100 starts a ring timer used to determine when the next alert should be produced.

As mentioned above, the signal received from the wireless device may be part of the Bluetooth™ HFP or a similar protocol. One of the features of the Bluetooth™ HFP permits audio communications to be transferred from a wireless device (such as a cellular telephone, smartphone, or PDA) to a hands free device (such as a headset). Using the HFP, if the communication received by the wireless device is an audio communication then, when the notification apparatus 100 receives the HFP signal from the wireless device indicating that a communication has been received at step 406 of method 400, it also receives the audio channel associated with the communication. In this case, the notification apparatus 100 preferably redirects the audio channel back to the wireless device in order for the user to respond to the communication.

In general, the notification apparatus 100 must wait for the user to answer the communication before it redirects the audio channel back to the wireless device. If the audio channel was immediately redirected back to the wireless device, in many cases, the handset would malfunction. The method used to determine if the communication has been answered by the user again depends on the type of protocol supported by the wireless device.

Where call status polling is not supported by the wireless device, such as when only basic HFP is supported, the method proceeds from step 504 to step 506. At step 506, the notification apparatus 100 waits for an audio link, such as a Synchronous Connection-Oriented (SCO) link, to be established or for a key press indicating that the user has responded to the incoming communication. When one of these has been detected, the method proceeds to step 514 where the notification waits for a short period of time, for example 200-400 milliseconds, before redirecting the audio channel back to the wireless device at step 516. This wait time has been found to be desirable in order to prevent many types of wireless devices from malfunctioning.

On the other hand, if the wireless device does support call status polling, for example where the full HFP is supported, then the method proceeds from step 510 to step 512 where the notification apparatus 100 uses call status polling to determine when the user has responded to the communication. A periodic signal is sent from the notification apparatus 100 to poll for a status update from the wireless device. The notification apparatus continues to send status poll signals until it receives a message in response to one of these signals indicating that a call is in progress.

Each time the ring timer, described above, expires, the method returns to step 508 where the user is again alerted to the communication. The ring timer is then restarted at step 510 and the method returns to step 512 to wait for the user to answer the communication.

When the notification apparatus 100 receives a message from the wireless device, in response to a call status poll, which indicates that a call is in progress, the ring timer is stopped and the method proceeds to step 514.

At step 514, as described above, the notification apparatus 100 waits for a short period of time, for example 200-400 milliseconds, before redirecting the audio back to the wireless device at step 516. The method 400 is then completed.

In some embodiments, if neither type of Bluetooth™ HFP is supported by the wireless device, this will be automatically detected by the notification apparatus 100. The notification apparatus 100 may then automatically reconnect to the wireless device using, for example, a serial profile. This serial profile may then be stored in a memory associated with the notification apparatus 100 for use in future connections to the same paired wireless device.

The notification apparatus 100 may also include an out of range alert feature. The out of range alert feature alerts the user when the notification apparatus 100 has left the wireless communication range of the wireless device, possibly meaning that the wireless device has been unintentionally left behind.

In some embodiments, as the notification apparatus 100 gets further away from the device, the signal strength of the connection between the notification apparatus 100 and the wireless device becomes weaker until the connection is dropped. The notification apparatus 100 may detect that the connection has been dropped and provide the out of range alert.

An out of range alert preferably does not result from a user-initiated disconnection. The out of range feature preferably provides a unique alert which is distinguishable from alerts used in relation to other types of events.

In some embodiments, when the notification apparatus 100 leaves the wireless communication range of the wireless device, the notification apparatus 100 may automatically attempt to reconnect to the wireless device for a short period of time before the out of range alert is activated. This automatic attempt to reconnect to the wireless device is desirable in order to reduce the number of false alerts which may be common when a wireless device is running in a low power mode.

While what has been shown and described herein constitutes some exemplary embodiments of the present invention and while some variations of the embodiment have also been described, it should be understood that various modifications and adaptations of such embodiments can be made without departing from the present invention, the scope of which is defined in the appended claims.

1. A wireless communication-enabled notification apparatus for a wireless device, the notification apparatus comprising:
a) a housing including a base plate;
b) an anchoring device coupled to the base plate;
c) an integrated circuit located in the housing, wherein the integrated circuit comprises a wireless transceiver, wherein the wireless transceiver is adapted for wireless communication with the wireless device; and
d) a signaling device located in the housing, the signaling device adapted for activation by the integrated circuit, wherein the signaling device is adapted to alert the user of the wireless device to a notification signal sent by the wireless device in response to an event.

2. The apparatus of claim 1, wherein the anchoring device is a garment pin.

3. The apparatus of claim 1, wherein the anchoring device is a clasp.

4. The apparatus of claim 1, wherein the anchoring device is a magnet.

5. The apparatus of claim 1, further comprising a face plate coupled to the housing.

6. The apparatus of claim 1, further comprising a rechargeable battery located in the housing.

7. The apparatus of claim 1 wherein the signaling device emits an audible signal to alert the user.

8. The apparatus of claim 1 wherein the signaling device emits visible light to alert the user.

9. The apparatus of claim 1 wherein the signaling device is adapted to vibrate to alert the user.

10. The apparatus of claim 1 wherein the signaling device is further adapted to alert the user when the wireless device has left a wireless communications range of the notification apparatus.

11. The apparatus of claim 1 wherein the wireless transceiver is a Bluetoothυ transceiver.

12. The apparatus of claim 1 wherein, if an audio channel is directed to the notification apparatus by the wireless device with the notification signal, the integrated circuit is further adapted for determining when the user has responded to the event and redirecting the audio channel back to the wireless device after the user has responded to the event.

13. The apparatus of claim 12 wherein the integrated circuit is further adapted for determining a wireless protocol supported by the wireless device.

14. The apparatus of claim 13 wherein the integrated circuit is further adapted for utilizing call status polling to determine when the user of the wireless device has responded to the event.

15. The apparatus of claim 13 wherein, if the wireless protocol does not enable call status polling, the integrated circuit is further adapted for determining when the user of the wireless device has responded to the event by at least one of: determining that an input key has been pressed on the wireless device and determining that an audio connection has been established by the wireless device.

16. The apparatus of claim 13 wherein a different alert is produced by the signaling device for each of at least a portion of wireless protocols.

17. A method for alerting the user of a wireless device to an event using a wireless communication-enabled notification apparatus, the method comprising:
a) the notification apparatus receiving a notification signal from the wireless device;
b) the notification apparatus alerting the user by emitting a signal; and
c) if an audio channel is directed to the notification apparatus by the wireless device with the notification signal, the notification apparatus redirecting the audio channel back to the wireless device.

18. The method of claim 17 wherein the method further comprises:
d) the notification apparatus alerting the user when the wireless device has left a wireless communications range of the notification apparatus.

19. The method of claim 17 wherein the notification signal is received by the notification apparatus using Bluetooth™ protocol.

20. The method of claim 17 wherein step c) further comprises the notification apparatus determining that the user has responded to the event, and redirecting the audio channel back to the wireless device after the user has responded to the event.

21. The method of claim 20 wherein step c) further comprises the notification apparatus determining a wireless protocol supported by the wireless device.

22. The method of claim 21 wherein step c) further comprises the notification apparatus utilizing call status polling to determine when the user of the wireless device has responded to the event.

23. The method of claim 21 wherein step c) further comprises, if the wireless protocol does not enable call status polling, the notification apparatus determining that the user of the wireless device has responded to the event by at least one of: determining that an input key has been pressed on the wireless device and determining that an audio connection has been established by the wireless device.

24. The method of claim 20 wherein the signal emitted in step b) is different for each of at least a portion of wireless protocols.
